(19) United States
(12) Patent Application Publication
(10) Pub. No.: US 2009/0269455 A1
(43) Pub. Date: Oct. 29, 2009

(54) PROTEIN-BASED FOOD PRODUCT AND ASSOCIATED PRODUCTION METHOD

(75) Inventors: Jutta Hoffmann, Nussloch (DE); Michael Ahlers, Eberbach (DE)

Correspondence Address: LEYDIG VOIT & MAYER, LTD, 700 THIRTEENTH ST. NW, SUITE 300, WASHINGTON, DC, 20005-3960, US

(73) Assignee: GELITA AG, Eberbach (DE)

(21) Appl. No.: 12/499,184

(22) Filed: Jul. 8, 2009

Related U.S. Application Data
(63) Continuation of application No. PCT/EP2007/010702, filed on Dec. 8, 2007.

(30) Foreign Application Priority Data
Jan. 9, 2007 (DE) 10 2007 002 295.8

(51) Int. Cl. A23L 1/305; A23L 1/0562; A23P 1/10

(52) U.S. Cl. 426/564; 426/456; 426/385

(57) ABSTRACT

The aim of the invention is to obtain a food product, in particular a snack product, which has a favourable nutrient physiology and a crispy, brittle texture, and an associated production method. To achieve this, the food product is substantially devoid of starch and has a foamed structure and the solid content has a protein fraction of at least approximately 25% by weight, at least 65% by weight of the protein fraction consisting of gelatin and/or collagen hydrolysate.

### BACKGROUND OF THE INVENTION

The present invention relates to a food product, in particular a snack product, based on protein. The invention further relates to a method for producing a food product of this type.

Products which are characterized during consumption by a crispy, brittle texture enjoy an especially great popularity as snacks (for example, crisps, crackers, pretzel sticks or the like). Snack products of this type consist almost exclusively or to a large extent, of carbohydrates, in particular starch, with a high fat fraction also being added to this in many cases, as the desired crunchy texture is obtained by deep frying (for example, potato crisps).

Because of this high carbohydrate and, optionally, fat fraction, these snack products are extremely disadvantageous from the nutritional point of view, so there is a need for alternative products. DE 30 39 348 A1 describes an extruded, foamed protein-based snack product with a content of 51 to 95% by weight protein in the dry part, the protein consisting of 30 to 70% by weight caseinate and optionally casein, 2 to 25% by weight cereal protein and 10 to 70% by weight soy protein. However, these products also contain carbohydrates and fat, which are above all also introduced together with the soy protein and the cereal protein into the product.

### BRIEF SUMMARY OF THE INVENTION

The object of the present invention consists in proposing a food product, in particular a snack product and a method for its production, which is nutritionally advantageous and simultaneously has a crispy, brittle texture.

This object is achieved according to the invention in the food product of the type mentioned at the outset in that the food product has a solid content of 80% by weight or more, is substantially devoid of starch and has a foamed structure, the solid content having a protein fraction of 25% by weight or more, of which 65% by weight or more consists of gelatin and/or collagen hydrolysate.

The food products according to the invention are not only suitable for human consumption, but can also be used as animal food, for example for dogs and fish.

### BRIEF DESCRIPTION OF THE DRAWING

FIG. 1 shows a slightly schematic view of an LM-micrograph of a breaking point of a crisp according to the invention produced according to Example 1.

### DETAILED DESCRIPTION OF THE INVENTION

The term “substantially devoid of starch” is to be understood in the scope of the present invention in that the food product has a starch fraction of about 5% by weight or less. The starch fraction may, however, also be significantly lower or, as a function of the purity of the raw materials used, substantially zero. Food products of this type according to the invention are suitable, in particular, as food for celiacs, who suffer from an intolerance to gluten. In any case, protein, i.e., gelatin and/or collagen hydrolysate is used as the basis for the food product according to the invention, which is advantageous compared to products based on starch in two respects: protein is not only nutritionally more favourable, but also brings about a more rapid satiation effect than starch, so the phenomenon frequently occurring in snack products that excessive quantities of the product are consumed is counteracted.

Conventional potato crisps are sometimes highly loaded with cancer-causing acrylamide because of their production method. It is produced in the Maillard reaction when overheating starch, in particular when deep frying. The snack product according to the invention is substantially devoid of starch and the production process does not need any high temperatures. Thus the risk of acrylamide formation is sharply reduced.

Soy proteins, caseinate, milk proteins and chicken protein are suitable, in particular, as further proteins, which may supplement the content of gelatin and/or collagen hydrolysate. These further proteins may be used individually or as a mixture of two or more further proteins and may be up to 35% by weight of the protein content.

In accordance with a solid content of 80% by weight or more, the water content (moisture) of the food product according to the invention is 20% by weight or less.

The food product according to the invention is, in particular, also much less harmful for an overweight person than conventional snack products.

The desired texture, i.e., the crispness and brittleness described above, is achieved in the context of the present invention, on the one hand, in that the food product has a foamed structure. However, these requirements cannot be met with a foamed structure from a conventional commercial gelatin (for example with a Bloom value of 200 to 300 g) alone, as a product is obtained in this case with a texture that is sticky and becomes tough during chewing.

Surprisingly, in the context of the present invention it was established that a crispy and brittle product which does not have this disadvantage can be produced by a reduction in the mean molecular weight of the protein used.

A low-Bloom gelatin (with, for example, about 100 Bloom), for example, alone or a mixture of various gelatins with different Bloom values, can be successfully used here optionally together with collagen hydrolysate. Very interesting products from a sensory point of view can be produced, for example, with a high-Bloom gelatin in combination with collagen hydrolysate.

In a preferred embodiment of the invention, the protein fraction in the solid content is 50% by weight or more, more preferably 80% by weight or more. These food products are suitable, in particular, for nourishment with a high protein content.

The remaining protein fraction may be formed, for example by flavours, spices, vegetable pieces or the like, or in the case of sweet food products, by flavours, fruit pieces, nuts and the like.

Moreover, the food products according to the invention may be decorated on their surface with fruit, vegetable, nut or other solid food products. The food product according to the invention in this case takes on the role of a carrier for this decoration. However, such decorations are not included in the calculation of the composition of the food product.

The Bloom value gives the gel strength of a 6.67% by weight gelatin solution gelled at 10° C. and is determined according to the standard Bloom test, which is described in the 4^{th} edition of the European Pharmacopoeia (Ph. Eur. 4). Low-Bloom gelatins, in comparison to conventional, higher-Bloom gelatin types, have a lower mean molecular weight.

According to one variant of the invention, the protein fraction of the food product comprises gelatin and 10% by weight or more of collagen hydrolysate. In contrast to gelatin, which is already in turn a hydrolysis product of collagen, the term “collagen hydrolysate” in the scope of the present invention is to be taken to mean a product hydrolysed to an extent which no longer gels under the conditions of the standard Bloom test, i.e., has a Bloom strength of zero g. Collagen hydrolysate can also, in particular, be produced by the enzymatic hydrolysis of gelatin.

A fraction of 10% by weight collagen hydrolysate already leads to a noticeable effect on the texture of the food product according to the invention. In preferred embodiments, the protein fraction comprises 35% by weight or more collagen hydrolysate. In the selection of the protein fraction, the Bloom value of the gelatin used also, in particular, plays a part, i.e., in a high-Bloom gelatin, more collagen hydrolysate is preferably used than in low-Bloom gelatin to achieve the same effect.

Excessive fractions of collagen hydrolysate may lead to a gritty texture of the food product. The protein fraction therefore preferably comprises up to 85% by weight collagen hydrolysate, in particular when using high-Bloom gelatin. Particularly preferred is a fraction of collagen hydrolysate of up to 80% by weight. Fractions of 45 to 75% by weight collagen hydrolysate frequently lead to optimal results.

The collagen hydrolysate, which is typically used in the context of the present invention, has a mean molecular weight of about 0.1 to about 30 kDa. The mean molecular weight is preferably in the range of about 0.5 to about 20 kDa, in particular about 1 to about 12 kDa.

The texture of the food product according to the invention during consumption is also influenced by its water content. A water content of about 8 to about 14% by weight, in particular of about 10 to about 12% by weight is preferred. In the case of excessive water contents, the food product tends to feel soft and spongy during chewing. In comparison to known starch-based snack products, the food product according to the invention is distinguished by a lower absorption of water from the surroundings, so it stays fresh and crispy for longer after opening the packaging.

The food product preferably comprises salt, spices and/or flavourings. In this case, all the flavours can be implemented which are also known in conventional snack products, for example paprika, onion or vinegar flavour.

A typical fraction of spices and/or flavourings and/or salt is about 2 to 6% by weight of the total weight of the food product according to the invention.

Taking into account the aim of offering a food product which is as devoid of starch as possible, the spices are selected such that they have a carbohydrate fraction of 45% by weight or less.

The spices and flavourings may also be accompanied by a fat fraction, which, however, regularly does not exceed about 3% by weight based on the fraction of spices/flavourings.

Said additives may be homogeneously distributed in the protein fraction. However, it is particularly favourable if the salt, the spices and/or the flavourings are applied to the outer surfaces of the food product. It has been shown that in this case, lower quantities of additives have to be used to achieve the same taste effect.

In a particular embodiment of the invention, the food product comprises one or more sugars, sugar substitutes and/or synthetic sweeteners. In this manner, the food product according to the invention can be used in the confectionary sector, for example, as an alternative devoid of starch (and also devoid of carbohydrate when using sweeteners) to biscuits or the like.

If sugar is used as a component of the recipe, a fraction of gelatin of about 6% by weight or more of the total weight of the solid fractions is recommended to stabilise the foamed structure in the production process.

However, food products according to the invention devoid of sugar are also particularly preferred.

The food product is preferably devoid of fat. “Devoid of fat” is taken to mean a content of about 3% by weight or less of the total weight of the food product in conjunction with the present invention. An addition of fat is not necessary in the scope of the present invention either for taste reasons, or for reasons concerning the production method, as is necessary, for example, when deep frying potato crisps. The food product according to the invention therefore provides the possibility of an alternative, which is devoid of starch and fat, to conventional snack products.

In addition to the selection of the raw materials, the density of the food product also has an influence on its texture during consumption. During the production of the foamed structure in the course of the production method according to the invention (see below), the density can be set within a broad range and is preferably in the range of about 0.05 to about 0.8 g/cm³, in particular of about 0.1 to about 0.5 g/cm³. The mean pore size of the foamed structure is preferably in the range of about 30 μm to about 4 mm.

The food products of the present invention with very low specific densities (about 0.05 g/cm³ or more) are used, for example, as fish food.

Food products for human consumption generally have specific densities of about 0.1 g/cm³ or more.

Above about 0.8 g/cm³, the firmness to the bite of the food product according to the invention frequently becomes too great. Preferred specific densities are frequently about 0.5 g/cm³ or less.

The food product according to the invention can be offered in various forms, for example in the form of crisps, crackers, biscuits, croutons or the like. It can also be used in particular as a snack or in the form of croutons to season salads or soups. Cereal substitute products are a further form. Use as a filler in chocolate bars is also possible.

The aforementioned object is achieved according to the invention in the method of the type mentioned at the outset in that the method comprises:

a) providing an aqueous solution, which contains 5 to 60% by weight gelatin and/or collagen hydrolysate;

b) foaming the aqueous solution; and

c) drying the foamed solution, a food product with a foamed structure being obtained.

The production method according to the invention is relatively simple to carry out as the food product does not have to be extruded, deep fried or baked. The desired crispy texture of the product is obtained, in particular, by foaming the desired raw materials and drying the solution with the formation of a solid foamed structure. Extrusion, however, has advantages in the industrial production process for crisp products.

The criteria for selecting the gelatin and optionally the collagen hydrolysate has already been described in conjunction with the food product according to the invention.

The selection of the total concentration of gelatin and/or collagen hydrolysate in the starting solution in step a) takes place from the point of view that the product breaks after drying with too low a concentration and, with too high a concentration, the foaming of the solution is problematical and, in addition, the product becomes too hard. Particularly good results are obtained if the aqueous solution contains a total of 20 to 40% by weight gelatin and/or collagen hydrolysate.

Further soluble and insoluble recipe constituents are preferably added to the aqueous solution before foaming. Larger particles, in particular, such as, for example, nuts, vegetable and/or fruit pieces, may also be added to the foam after foaming or scattered on the product.

The foaming of the solution can take place by means of various techniques. The solution is preferably whisked mechanically, in particular by means of a whisking machine, a pressure whisking machine or a static mixer. The foaming may furthermore take place by means of the introduction of a gas flow, in particular an air flow, into the solution.

The wet density of the foamed solution may be influenced by the selection of different foaming methods and/or the intensity of the foaming. This has a direct influence on the density of the food product produced after drying and on the mean pore size of the foamed structure. As has already been described above, these factors in turn influence the texture (crispiness, brittleness) of the food product.

The solution is preferably provided at a temperature of about 40° C. or more, in particular when the gelatin forms a constituent of the recipe of the aqueous solution. The temperature here is more preferably about 60° C. or more.

The aqueous solution in step (b), on the other hand, is preferably whisked at a temperature in the range of about 20° C. to about 50° C.

Depending on the desired form of the product, the foamed solution may be poured into a corresponding mould before drying. The foamed solution is particularly preferably applied, before drying, to a support, in particular a belt, a cylinder or the like. This allows a continuous production method and supplies a flat product, which can then be cut or broken, for example, into individual pieces of the desired size.

In a further embodiment of the method according to the invention, the foamed solution is shock-frosted before drying. Shock frosting preferably takes place in portions, in particular by introducing drops of the foamed solution into liquid nitrogen. In this manner, products with a spherical form may be obtained.

The foamed solution is preferably dried at a temperature of below about 60° C., more preferably below about 30° C. Before or during the drying process, the gelatin used gels so there is a risk at temperatures which are too high of the gelatin melting again and the foamed structure collapsing. To accelerate the gelling, the foamed solution may also be cooled before drying, which advantageously takes place in that the foamed solution is applied, for example, to a cooled conveyor belt or a cooled cylinder.

The relative humidity during drying of the foamed solution is preferably about 10 to about 45%, in particular about 10 to about 25%. The drying can also be carried out in two or more stages, i.e., with an upwardly stepped temperature and/or a downwardly stepped relative humidity.

A further preferred possibility consists in freeze drying the foamed solution. This is a possibility in particular following the above-described shock-frosting.

In the method according to the invention, salt, spices and/or flavourings can either be added to the aqueous solution before foaming or be applied after foaming to the outer surfaces of the food product. The second variant, as already mentioned, is preferred in as much as a greater taste effect can be achieved in this case with the same quantity.

These and further advantages of the invention will be described in more detail with the aid of the following examples.

### Example 1

### Production of Salty Snack Products

An aqueous solution was produced, which contained 7.5% by weight pork rind gelatin (260 Bloom), 22.5% by weight collagen hydrolysate (mean molecular weight 3 kDa) and a total of 3% by weight salt and spice mixture. As an alternative to pork rind gelatin, beef connective tissue gelatin with the same Bloom value may be used.

The solution was whisked by means of a pressure whisking machine called “Mondomix Haas” type VS-06 with the following parameters: rotational speed of the pump: 100 rpm, entry temperature: 60° C., rotational speed mixing head: 1000 rpm, pressure in the mixing head: 3.4 bar, introduction of air: 49.1 l/h, counter pressure: 3 bar, exit temperature: 31.7° C., wet-density foam: 0.3 g/cm³.

The foam was applied to baking paper at a height of 1.5 mm by means of a spreading knife. Once the foam was solid it was cut into crisps 2×2 cm in size, which were dried at 26° C. and at a relative air humidity of 10%. The crisps were then broken at their cutting point.

In the sensory test, the crisps had a pleasantly crispy, brittle texture.

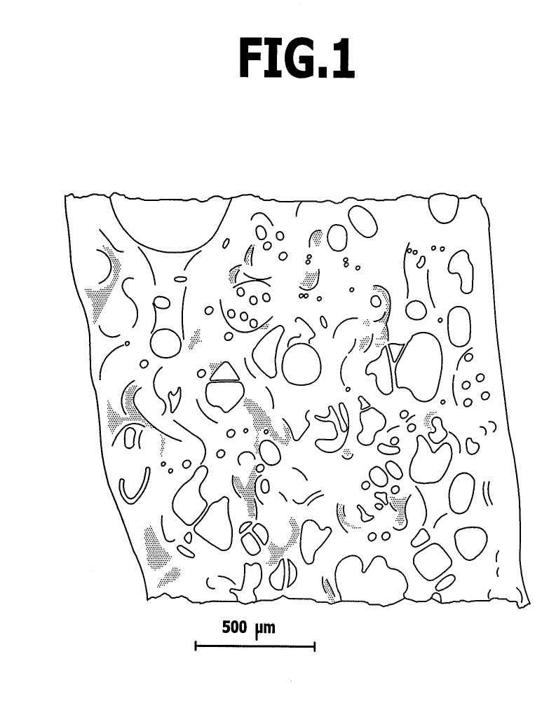

FIG. 1 shows a slightly schematic view of an LM-micrograph of a breaking point of a crisp according to the invention produced according to Example 1.

### Example 2

### Production of Salty Snack Products

An aqueous solution was produced, which contained 15% by weight pork rind gelatin (260 Bloom), 15% by weight collagen hydrolysate (mean molecular weight 3 kDa) and a total of 5% by weight salt and spice mixture.

The solution was whisked on a pressure whisking machine (as described in Example 1), so that a foam with a wet-density of about 0.3 g/cm³ was obtained.

The foam was distributed on a level support (baking paper) at a height of 1.5 mm with a spreading knife. Once the foam was solid, it was cut into crisps of about 2×2 cm in size, which were dried at 26° C. and at a relative air humidity of 10%.

In the sensory assessment, the crisps had a pleasantly crispy, brittle texture.

Similar crisps can be produced if, instead of the gelatin and the collagen hydrolysate, an aqueous solution with a fraction of 30% by weight of a gelatin with a Bloom value of about 100 g is used. In the sensory assessment, the crisps proved to be slightly less crispy, but still acceptable.

### Example 3

### Production of Salty Snack Products

15% by weight pork rind gelatin (120 Bloom)+15% by weight collagen hydrolysate (6 kDa) were brought into solution together in water. The further processing took place as described in Example 1.

Drying can be carried out at a maximum of 60° C. and at least 20° C. Different drying zones, i.e., different temperatures, can be used here. In the pilot laboratory, drying only took place at 26° C.

Drying of the crisps at temperatures below 20° C. or freeze drying is alternatively also possible.

In the sensory assessment, the crisps had a pleasantly crispy, brittle texture.

### Example 4

### Production of Salty Snack Products

22.5% by weight of beef bone gelatin (95 Bloom)+7.5% by weight collagen hydrolysate (6 kDa) were dissolved together in water. The further processing took place as in Example 1.

The product obtained is, however, from a sensory point of view, tougher than in Example 1. This product is suitable as animal food, for example as dog food.

### Example 5

### Production of Sweet Crisps

An aqueous solution with 12% by weight pork rind gelatin (140 g Bloom), 5% by weight collagen hydrolysate (mean molecular weight 3 kDa), 32.4% by weight sucrose, 5.5% by weight glucose syrup and 0.1% by weight citric acid, colourant and flavouring was produced. The foaming of the solution on a pressure whisking machine and the further processing took place as described in Example 1.

Sweet crisps with a pleasant crispy, brittle texture were obtained.

### Example 6

### Production of Sweet Crisps/Biscuits/Popped Cereals for Cereal Bars as a Carbohydrate Substitute

11% by weight pork rind gelatin (120 Bloom)+18% by weight collagen hydrolysate (3 kDa)+0.2% flavour, 1% citric acid, 1% colourant, 0.02% sweetener were processed to form an aqueous solution.

The use of sucrose instead of sweetener leads to a crystalline texture in the crisps, so that collagen hydrolysate is not absolutely necessary from a sensory point of view. In this example, as an alternative, gelatin with sugar alone may thus be used.

For the production of round shapes/spheres, for example for popped cereals (instead of flat products for crisps and biscuits), the foam is either poured into round moulds and taken from the mould after gelling, or introduced in drops into liquid nitrogen, and then dried in the drying cabinet like the crisps.

The sensory assessment produces a pleasantly crispy, brittle texture.

Further possible applications depending on the composition:

snack for dogs, fish food, cereal substitute products (popped cereals) for muesli with milk or in a cereal bar or as a biscuit layer in a bar or a chocolate.

### Example 7

### Storage Capacity of the Crisps

In the tests summarised in the following table, the storage capacity and the moisture absorption of various crisp recipes A to F were checked in comparison to conventional crisp products G to K.

It is firstly striking that the crisps according to the invention innately have a higher water content than conventional products and nevertheless have comparable sensory properties.

After 5 days of open storage, the water content of all the products increases. While the conventional crisp products (G to K) thereby lose their advantageous sensory properties, they remain substantially unchanged in the products (A to F) according to the invention.

Since the food products according to the invention, can also be produced in particular in snack or crisp form substantially without fat or even completely devoid of fat, the problem of becoming rancid during storage in air oxygen is also dispensed with.

| | | Water content after | |
|---|---|---|---|
| | Water content after | air-tight storage in a | |
| | opening, several | tin in gelatin crisps | Water content after 5 |
| Solid composition of | days after | more than 5 days | days storage, open, at |
| the samples [% by | production [% by | after production [% | 22° C. and about 50% |
| weight] | weight] | by weight] | r.h. [% by weight] |
| A | 11.2 | 14.4 | 15.0 |
| 75% gelatin A | | | |
| 25% hydrolysate A | | | |
| B | 10.8 | 13.6 | 13.9 |
| 50% gelatin A | | | |
| 50% hydrolysate B | | | |
| C | 10.4 | 11.2 | 14.8 |
| 100% gelatin B | | | |
| D | 9.8 | 9.8 | 14.5 |
| 50% gelatin C | | | |
| 50% hydrolysate C | | | |
| E | 8.3 | 10.5 | 13.3 |
| 50% gelatin C | | | |
| 50% hydrolysate C | | | |
| F | 9.8 | 11.1 | 13.5 |
| 25% gelatin C | | | |
| 75% hydrolysate C | | | |
| G | 1.7 | 1.8 | 4.9 |
| Potato crisps | | | |
| H | 1.6 | 2.3 | 7.5 |
| Potato crisps | | | |
| 30% less fat | | | |
| J | — | 4.2 | 7.1 |
| Crab crisps (Krupuk) | | | |
| K | 1.9 | 1.5 | 7.0 |
| Corn crisps | | | |

In the table the following mean:
gelatin A: beef bone gelatin 95 Bloom
hydrolysate A: collagen hydrolysate 6 KDa
gelatin B: beef connective tissue gelatin 50 Bloom
hydrolysate B: collagen hydrolysate 12 KDa
gelatin C: pork rind gelatin 260 Bloom
hydrolysate C: collagen hydrolysate 3 KDa

The collagen hydrolysate used in Example 7 was in each case obtained based on the raw material of pork rind. Other collagen hydrolysates, for example based on the raw material of beef connective tissue or beef bone can be used with the same advantages.

1. A food product based on protein with a solid content of about 80% by weight or more, wherein the food product is substantially devoid of starch and has a foamed structure, and wherein the solid content has a protein fraction of about 25% by weight or more, of which about 65% by weight or more consists of gelatin and/or collagen hydrolysate.

2. The food product according to claim 1, wherein the protein fraction is about 50% by weight or more of the solid content.

3. The food product according to claim 2, wherein the protein fraction is about 80% by weight or more of the solid content.

4. The food product according to claim 1, wherein the protein fraction comprises about 10% by weight or more collagen hydrolysate.

5-7. (canceled)

8. The food product according to claim 1, wherein the protein fraction comprises about 45 to about 75% by weight collagen hydrolysate.

9. The food product according to claim 1, wherein the collagen hydrolysate has a mean molecular weight of about 0.1 to about 30 kDa.

10. The food product according to claim 9, wherein the collagen hydrolysate has a mean molecular weight of about 0.5 to about 20 kDa.

11. The food product according to claim 1, wherein the food product has a water content of about 8 to about 14% by weight.

12-15. (canceled)

16. The food product according to claim 1, wherein the food product has a density of about 0.05 to about 0.8 g/cm³.

17. The food product according to claim 1, in the form of crisps, crackers, croutons, or cereal substitute products.

18. A method for producing a food product based on protein, comprising:
a) providing an aqueous solution, containing about 5 to about 60% by weight gelatin and/or collagen hydrolysate;
b) foaming the aqueous solution; and
c) drying the foamed solution, and obtaining a food product with a foamed structure.

19. The method according to claim 18, wherein the aqueous solution contains collagen hydrolysate with a fraction of 10% by weight or more based on the total content of gelatin and/or collagen hydrolysate.

20-21. (canceled)

22. The method according to claim 18, wherein foaming the aqueous solution includes whisking the aqueous solution at a temperature in the range of about 20° C. to about 50° C.

23-27. (canceled)

28. The method according to claim 18, wherein the foamed solution is cooled before drying and before or after moulding to a temperature of about 25° C. or less.

29. (canceled)

30. The method according to claim 18, wherein the foamed solution is shock-frosted before drying.

31. (canceled)

32. The method according to claim 18, wherein the foamed solution is dried at a temperature below about 60° C.

33-34. (canceled)

35. The method according to claim 18, wherein the foamed solution is freeze-dried.

36. The method according to claim 18, wherein drying the foamed solution is carried out in two or more stages, wherein the temperature of the first drying stage is lower than the temperature of the second drying stage.

37. The method according to claim 18, wherein drying the foamed solution is carried out in two or more stages, the first drying stage taking place at a higher relative humidity than the second drying stage.

38. (canceled)
